(19) United States
(12) Patent Application Publication
(10) Pub. No.: US 2006/0046726 A1
(43) Pub. Date: Mar. 2, 2006

(54) Communication method between a fixed telephone and a personal handyphone system mobile phone by means of a two-way conversation communication function

(75) Inventors: Cheng-Shing Lai, Taipei (TW); Xiao-Long Fan, Nankng (CN); Hong Ding, Nankng (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/135,360

(22) Filed: May 24, 2005

(30) Foreign Application Priority Data
Aug. 30, 2004 (TW) 093126005

(51) Int. Cl. H04Q 7/20

(52) U.S. Cl. 455/445; 455/426.1

(57) ABSTRACT

The invention relates to a communication method between a fixed telephone and a PHS mobile phone by means of a two-way conversation function, which comprises the steps of registering a PHS mobile phone and a fixed telephone having a PHS mobile two-way communication module installed therein in the same subsystem group to get connected, such that the PHS mobile phone and the fixed telephone can communicate with each other via a wireless channel interface; using the PHS mobile phone to send a voice to the fixed telephone; using the fixed telephone to send the voice to a communication terminal of the opposite party and then to the user's PHS mobile phone via the conversation mode; and enabling the PHS mobile phone to receive the incoming call of the fixed telephone or dial a telephone call via the fixed telephone.

### FIELD OF THE INVENTION

The present invention generally relates to a communication method between a fixed telephone and a PHS (personal handyphone system) mobile phone, more particularly to a communication method between a fixed telephone and a PHS mobile phone by means of a two-way voice communication function so as to fully utilize the wireless characteristics of the PHS mobile phone and the resources of the fixed telephone to complement the deficiencies of each other and achieve the goal of using the PHS mobile phone to receive the incoming call of the fixed telephone or dial a telephone call through the fixed telephone.

### BACKGROUND OF THE INVENTION

Fixed telephones are very familiar to everyone, since most family and corporate users have installed a fixed telephone, and it could be said that the fixed telephone is an integral part of our daily life in the communication network era. For business, contact or chatting, almost everyone has to use fixed telephones, and as the fixed telephone has developed for over a hundred years, the terminal has been developed from “cranking bar”, “dial” to “touch-tone”, but the fixed telephone has a regular telephone circuit without changing the nature of carrying a single tone business.

As telephone has been developed till now, the pace of our life is getting faster, and thus having a demand for mobile communications and multimedia application. The traditional way of developing fixed telephone no longer meets the users' requirements. Further, since the mobile communication business has been deregulated for privatization in recent years and mobile communication users grow drastically, therefore it is a trend for mobile phone to take over the fixed telephone business. Compared with fixed telephones, mobile phones have the mobile feature, which creates a huge opportunity for mobile phones. Particularly, a personal handyphone system (PHS) mobile phone is exquisite, fashionable, and inexpensive. Unlike fixed telephones, the PHS mobile phones is better than the fixed telephones, and the PHS phones cost much less. Therefore, most families install one or more PHS phones in addition to the fixed telephone installed at home.

Further, since the PHS mobile phone technology is developed rapidly and telecommunication companies strongly promote PHS mobile phones, so that the number of PHS mobile phone users is increased rapidly. In a short period of one or two years, the number and popularity of fixed telephone users will be taken over by the mobile communications, and many surveys also indicate that the percentage of consumers using mobile phones is higher than that fixed telephones, and even the percentage of mobile phone applications starts exceeding the percentage of fixed telephone applications at home.

However, if a user at home has an incoming call to the fixed telephone, the user usually has to give up the present business and location to walk to the location of the fixed telephone to receive an incoming call, and thus causing tremendous inconvenience to users.

As now that, more and more people are using this kind of communication terminal equipments. In the meanwhile, the fixed telephone and the PHS mobile phone users are increased rapidly, but at present no PHS mobile phone can receive the incoming call of the fixed telephone. Therefore, the inventor of the present invention notices this problem and meets the market requirements to aggressively develop the accessory functions of the PHS terminal equipments, so as to improve the competitiveness among the products of the same type.

### SUMMARY OF THE INVENTION

In view of the foregoing prior arts, it is obvious that most families and corporations have installed fixed telephones and mobile communication users grow rapidly in recent years; since mobile phones have its mobility feature, therefore families and corporations will have one or more PHS mobile phones. However, if a call is made to the fixed telephone, a user usually has to give up the present working business and location to walk to the position of the fixed telephone to receive the call, and thus casing inconvenience to the user. To meet the fast changing requirements, actual needs and solve the foregoing problems, the inventor of the present invention based on years of experience in the related industry to conduct extensive researches and experiments, and finally developed a communication method between a fixed telephone and a PHS mobile phone by means of a two-way conversation function in accordance with the present invention, in hope of fully utilizing the wireless characteristics of the PHS mobile phone and the resources of the fixed telephone to complement the deficiencies of each other.

It is a primary objective of the present invention to provide a communication method between a fixed telephone and a PHS mobile phone by means of a two-way conversation function, so that a user at home can use a PHS mobile phone to receive an incoming call from a fixed telephone within a distance of 100 meters or dial a telephone call through the fixed telephone, and thus bringing tremendous convenience to the user. To achieve the foregoing objective, the method includes the steps of registering a PHS mobile phone and a fixed telephone having a PHS mobile two-way communication module installed therein in the same subsystem group to establish the connection, such that the PHS mobile phone and the fixed telephone can communicate with each other via a wireless channel interface; using the PHS mobile phone to send a user's voice to the fixed telephone having a PHS mobile communication module; using a telephone circuit of the fixed telephone to send the user's voice to a communication terminal of the opposite party and then to the user's PHS mobile phone via the conversation mode; and achieving the function of using the PHS mobile phone to receive the incoming call of the fixed telephone or dial a telephone call through the fixed telephone.

Another objective of the present invention is to meet the market requirements and aggressively develop the accessory functions of the PHS mobile phone and equipment and improve the competitiveness of products of the same type, and fully using the wireless features of the PHS mobile phone and the resources of the fixed telephone to complement the deficiencies of each other.

The above and other objects, features and advantages of the present invention will become apparent from the following detailed description taken with the accompanying drawings.

### BRIEF DESCRIPTION OF THE DRAWINGS

FIG. 1 is a schematic block diagram of the structure of a telephone communication by using a PHS mobile phone conversation mode via a fixed telephone circuit;

FIG. 2 is a flow chart of establishing a connection between a PHS mobile phone and a fixed telephone according to the present invention;

FIG. 3 is a flow chart of receiving a telephone call of a PHS mobile phone via the fixed telephone according to the present invention; and

FIG. 4 is a flow chart of disconnecting a telephone call of a PHS mobile phone via the fixed telephone according to the present invention.

### DETAILED DESCRIPTION OF THE PREFERRED EMBODIMENTS

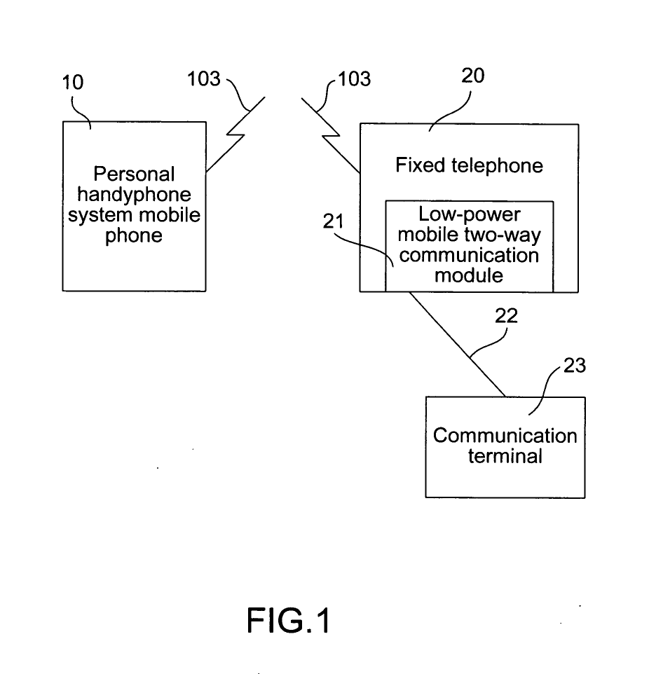

Referring to FIG. 1 for the communication method between a fixed telephone and a PHS mobile phone by means of a two-way conversation communication function in according to the present invention, the method comprises the steps of registering a Personal Handyphone System (PHS) mobile phone 10 and a fixed telephone 20 having a PHS mobile communication module 21 installed therein in a same subsystem group for establishing a connection, so that the PHS mobile phone 10 and the fixed telephone 20 can communicate with each other via a wireless channel interface 103; using the PHS mobile phone 10 to transmit a user's voice to the fixed telephone 20 having a PHS mobile conversation module 21 via a two-way conversation mode and then sending to a communication terminal 23 of an opposite party via a telephone circuit 22 of the fixed telephone 20, and using the telephone circuit 22 to send the opposite party's voice to the fixed telephone 20 and then transmit to the user's PHS mobile phone 10 by the two-way conversation mode, such that the PHS mobile phone 10 is used to achieve the objective of receiving an incoming call of the fixed telephone 20 or dialing a telephone call through the fixed telephone 20 within a distance of 100 meters via wireless communications.

In the present invention, the technical characteristics of the direct communication technology between the foregoing subsystem groups include a mutual communication without going through a cell station (CS), and the PHS mobile phone 10 and the fixed telephone 20 directly communicate with each other through a specific channel. The functional channels used for the direct communication between the subsystems include a signaling control channel (SCC) for controlling the physical time, a traffic channel (TCH) used for controlling the physical communication time, and a fast associated control channel (FACCH).

Further, users do not have to pay for the communications between the foregoing PHS mobile phone 10 and the fixed telephone 20 in accordance with the present invention. As to the way of registering for the group, it is a commonly used technology and thus will not be described here.

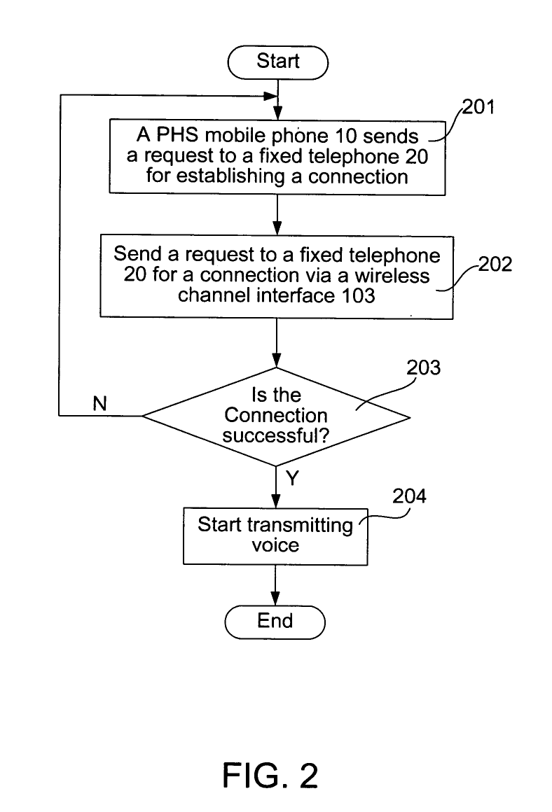

Referring to FIG. 2 for a preferred embodiment of the present invention, the procedure for using the PHS mobile phone 10 to make a phone call or establishing a connection with the fixed telephone 20 comprises the steps of:
Step (201): issuing a request to the PHS mobile communication module 21 of the fixed telephone for establishing a connection with the PHS mobile phone 10;
Step (202): issuing a request to the fixed telephone 20 via a wireless channel interface 103 for a connection, and then waiting for a reply;
Step (203): determining whether or not the reply for establishing the connection of the fixed telephone 20 is received; if yes, then go to Step (204); if no, return to Step (201) to issue a request again; and
Step (204): establishing a connection with the fixed telephone 20; and in the meantime, the PHS mobile phone 10 starts transmitting voices, and then ending the connecting procedure for this time.

In Step (203), the fixed telephone 20 installs a time-out control for its waiting for the reply; and if a predetermined time is reached, then the user may select to continue waiting or directly disconnect to issue the request for a connection again.

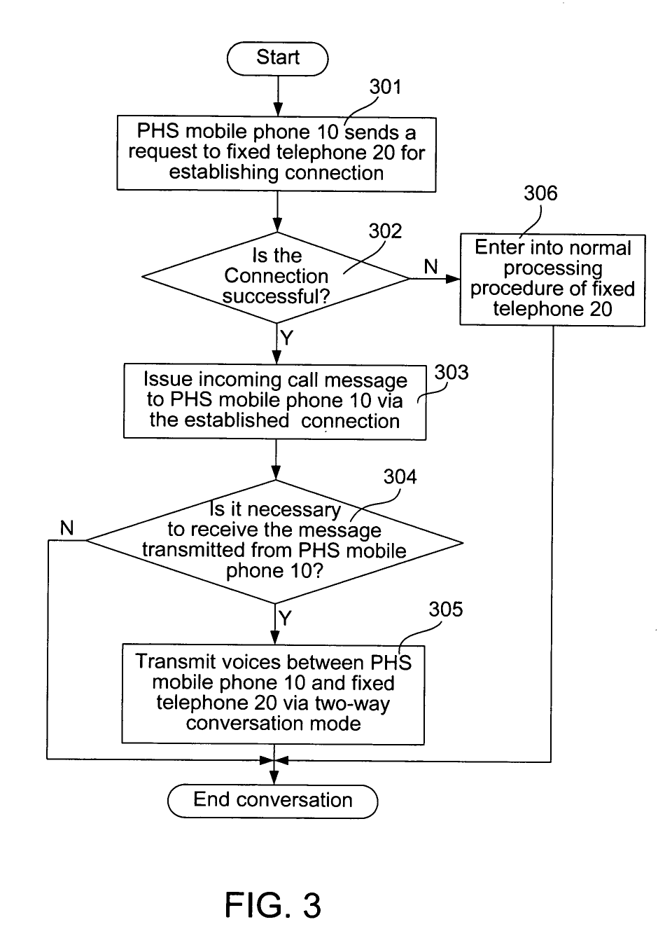

Referring to FIG. 3, the PHS mobile phone 10 receives a telephone call via the fixed telephone 20 in the process comprising the steps of:
Step (301): issuing a request to the PHS mobile phone 10 via the wireless channel interface 103 and waiting for a reply, when the fixed telephone 20 has an incoming call;
Step (302): determining whether or not the reply for establishing the connection of the PHS mobile phone 10 is received; if yes, go to Step (203); if no reply for establishing the connection or a message for rejecting the incoming call is received, then go to Step (306);
Step (303): issuing an incoming call message to the PHS mobile phone 10 through the established connection;
Step (304): determining whether or not the message transmitted from the PHS mobile phone 10 gives instruction to receive the incoming call; if yes, go to Step (305); if no, end the telephone call procedure for this time;
Step (305): transmitting voices between the PHS mobile phone 10 and the fixed telephone 20 through the two-way conversation mode, and then ending the telephone call procedure for this time; and
Step (306): entering into the standard processing procedure of the fixed telephone 20, and then ending the telephone call procedure for this time.

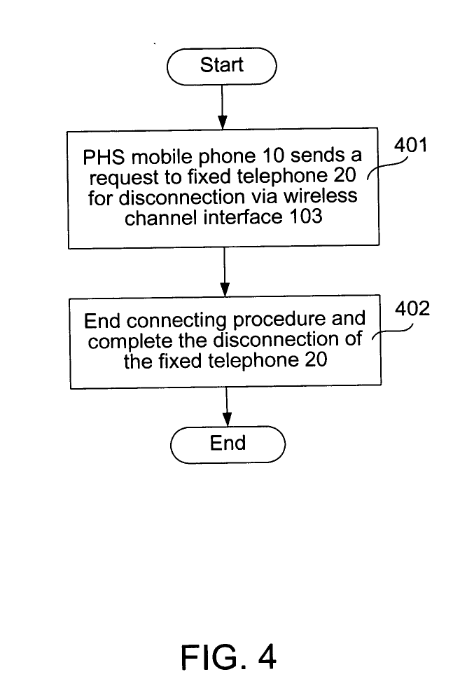

Referring to FIG. 4 for the processing procedure of disconnecting the PHS mobile phone 10 and the fixed telephone, the procedure comprises the steps of:
Step (401): issuing a request to the PHS mobile communication module 21 of the fixed telephone 20 through the wireless channel interface 103 by the PHS mobile phone 10 for a disconnection; and
Step (402): ending the connecting procedure; in the meantime, completing the disconnection with the fixed telephone 20.

While the invention has been described by means of specific embodiments, numerous modifications and variations could be made thereto by those skilled in the art without departing from the scope and spirit of the invention set forth in the claims.

What is claimed is:

1. A communication method between a fixed telephone and a personal handyphone system (PHS) mobile phone by means of a two-way conversation communication function, which registers a PHS mobile phone and a fixed telephone having a PHS communication module installed therein in a same subsystem group for establishing a connection, and allows said PHS mobile phone and said fixed telephone to communicate with each other via a wireless channel interface, comprising the steps of:
using said PHS mobile phone to transmit a user's voice to said fixed telephone having a PHS mobile communication module through a two-way conversation mode;
transmitting said voice to a communication terminal of an opposite party via a telephone circuit of said fixed telephone; and
transmitting a voice of said opposite party to said fixed telephone through said telephone circuit and then to said PHS mobile phone of said user by said conversation mode;
thereby said PHS mobile phone is used to receive an incoming call from said fixed telephone via a wireless communication or dial a telephone call via said fixed telephone.

2. The communication method between a fixed telephone and a personal handyphone system (PHS) mobile phone by means of a two-way conversation communication function of claim 1, wherein said PHS mobile phone issues a request to said fixed telephone for establishing a connection by a process comprising the steps of:
issuing a request from said PHS mobile phone to said PHS mobile communication module of said fixed telephone for establishing a connection;
issuing a request to said fixed telephone via a wireless channel interface for establishing a connection and waiting for a reply; and
starting transmitting voices after said fixed telephone has established a connection.

3. The communication method between a fixed telephone and a personal handyphone system (PHS) mobile phone by means of a two-way conversation communication function of claim 2, further comprising a time-out control while waiting for a reply from said fixed telephone, enabling a user to select to continue waiting or disconnect directly to reissue another request for establishing a connection when a predetermined time is reached.

4. The communication method between a fixed telephone and a personal handyphone system (PHS) mobile phone by means of a two-way conversation communication function of claim 2, wherein said PHS mobile phone receives a telephone call via said fixed telephone by a process comprising the steps of:
issuing a request to said PHS mobile phone via said wireless channel interface for establishing a connection when said fixed telephone has an incoming call, and then waiting for a reply; and
issuing an incoming call message to said PHS mobile phone through said established connection after said PHS mobile phone is connected;
thereby when said message transmitted from said PHS mobile phone is instructed to receive an incoming call, said voice is transmitted between said PHS mobile phone and said fixed telephone through said two-way conversation mode.

5. The communication method between a fixed telephone and a personal handyphone system (PHS) mobile phone by means of a two-way conversation communication function of claim 4, further comprising a step of entering into a standard processing procedure when said message transmitted from said PHS mobile phone has no reply for said established connection or reject said incoming call.
